(19) United States
(12) Patent Application Publication
(10) Pub. No.: US 2011/0259360 A1
(43) Pub. Date: Oct. 27, 2011

(54) DENTAL FLOSS

(76) Inventor: Stuart Marvin, Monsey, NY (US)

(21) Appl. No.: 12/764,616

(22) Filed: Apr. 21, 2010

(51) Int. Cl. A61C 15/04

(52) U.S. Cl. 132/325

(57) ABSTRACT

A length of dental floss having spaced members, each member including one or more structural features that is/are configured to remove material trapped between teeth. One structural feature included on the floss is a loop, bound at the location of a first knot along a length of dental floss or tape that defines a yieldable snare for capturing food. Another structure that can be included in certain implementations is a brush, which also can be bound at the first knot, that is moveable independently of the loop and is shaped to remove debris from gumline or from between two teeth or from between two implants. Floss or tape so-constructed can be provided in a dispenser having a spindle that supports the floss, a housing that supports the spindle for rotation, an aperture shaped to permit unimpeded withdrawal of the floss and the structural features thereupon, and a cutting element.

### FIELD OF THE INVENTION

This invention relates to dental floss, and more particularly to structures carried on dental floss that are configured to assist in the removal of material trapped between teeth, crowns, and other dental structures.

### BACKGROUND OF THE INVENTION

Dentistry has a saying, “You don't have to floss all of your teeth, only floss the teeth you wish to save”. The present invention concerns improvements in floss.

As people age there is a natural recession of the gums, sometimes exacerbated by current or past periodontal disease. This creates larger openings in between the teeth where the gum tissue used to be. When teeth are replaced with fixed bridgework, some natural spaces are left to allow proper flossing. As in many other situations these larger spaces make it easier for food to collect and enhance the chance of decay forming around the gum line areas in between the teeth. These larger spaces accumulate more than the normal amount of food and therefore it is more difficult to remove the food with regular floss.

Floss is fairly effective in removing food at the gumline in between teeth. Current floss is available in modified forms, but none is available that provides a structure that adequately addresses the problem of large food collecting spaces between teeth. However, the present invention addresses these and other needs in the art.

### SUMMARY OF THE INVENTION

Accordingly, the present invention provides a length of dental floss having a series of spaced structures disposed along the length of the floss that are adapted to snare material trapped between teeth, crowns, and other dental structures, provide a brush for such locations, or both.

In one aspect of the invention, a dispenser is provided for dispensing a length of dental floss or tape (more generally “floss”) having a spindle that supports a length of floss, ,a housing that supports the spindle for rotation and further has an aperture for withdrawing the floss and a cutting element. The floss has at least a first knot along the length and at least a first loop disposed at the first knot. The loop defines a yieldable snare that passes through the aperture of the dispenser.

In a related aspect, the floss within the dispenser can optionally have ends extending from the knot that provide a brush for removal of debris from gumline or from between two teeth or from between two implants.

In another aspect of the invention, a length floss has first and second ends and at least a first knot along the length. At least one loop is bound at the location of the first knot and defines a yieldable snare for capturing food.

In still another aspect of the invention, a length of floss has first and second ends, at least a first knot along the length, at least one loop bound at the location of the first knot that defines a yieldable snare for capturing food, and a brush also bound at the first knot. The brush is moveable independently of the loop(s) and is shaped to remove debris from gumline or from between two teeth or from between two implants.

Further aspects, features and advantages will be apparent upon review of the following Detailed Description of Certain Embodiments of the Invention and the accompanying Drawing Figures.

### BRIEF DESCRIPTION OF THE DRAWING FIGURES

FIG. 1 is a side elevation of a length of dental floss according to the present invention;

FIG. 2 is a detail view of a portion of the length of dental floss of FIG. 1;

FIG. 2A is a cross section taken along line B-B of FIG. 2 showing a variation of a floss structure that is specially adapted to provide kink resistance;

FIG. 3 is a side elevation of floss according to FIG. 1 disposed between two teeth;

FIG. 4 is a floss dispenser shown partially broken away; and

FIG. 5 is a detail view taken along line A-A of FIG. 4 showing an edge configured to provide smooth withdrawal of the length of dental floss of FIG. 1 from the dispenser of FIG. 4.

### DETAILED DESCRIPTION OF CERTAIN EMBODIMENTS OF THE INVENTION

The invention is described in connection with an arrangement upon dental floss having a nominal diameter of approximately 1 mm, but could be applied with equal advantage to dental tape as will be appreciated from the following description.

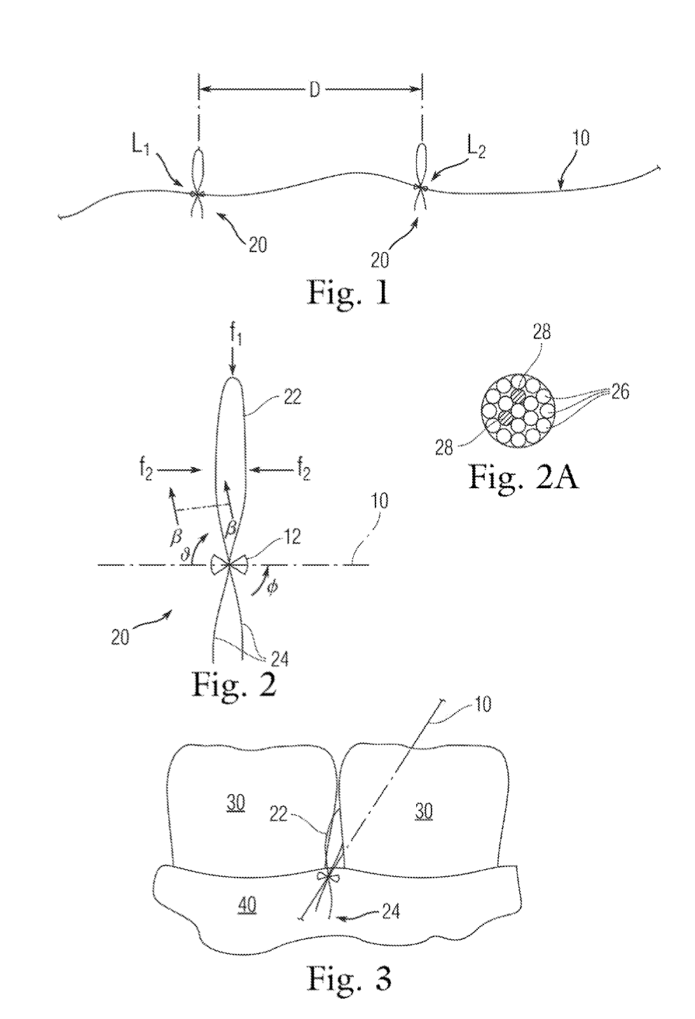

As shown in FIG. 1, the dental floss according to the present invention is a length 10 of dental floss, of conventional material, having formed on it a plurality of structures 20, each spaced a distance apart from one another, and preferably spaced a uniform distance D. For example, D can be about 4 inches to about 6 inches which allows material between each structure for wrapping floss about a finger for use by a person. As described in more detail below, the configuration and size of the structures along the length 10 can be varied, as well as the distance D between them.

In a preferred arrangement as shown in the detail view of FIG. 2, each structure 20 comprises a loop 22 and ends 24. Both the loop 22 and the ends 24 extend away from a knot 12, defined in or along the floss 10, which binds the loop and ends to a location L₁, L₂, L₃, . . . , L_{N} along the floss. The loop and ends can assume a variety of angles θ and φ relative to the length of the floss 10, and as such yield to forces imparted by teeth and upon exiting a dispenser, as discussed below.

In one variation, the loop 22 at each location along the floss 10 is the same size. For instance, the loop can extend away from the floss 10 by about ¼ ″to about ½″. When all loops 22 are the same size, a spool of floss can be loaded in a dispenser and labeled according to the loop size. Also, when all loops are the same size, a dispenser can be fitted with plural spools each dispensing a respective size loop 22. In this way, a user can select a small medium, or, perhaps, a large loop size to use between different teeth and dental structures.

In another variation, the size of the loops 22 can increase from location to location along the length of floss 10. In this variation, the user is provided with a choice of loop sizes from which to select along a single length of floss 10. Also, a single dispenser can dispense plural loop sizes in this variation.

The loop 22 increases the surface area of the floss 10 and provides a localized structure to aid in the removal of food and debris between teeth and around the gumline. Unlike known protuberances and simple knots that have been provided on floss in the prior art, the loops 22 not only increase the surface by two to approximately five times the nominal diameter of floss, their configuration can resiliently give yield between teeth and, as such, are more gentle on the gums and concurrently provides a snare to draw out debris. Moreover, the yielding property of the structure 20 enables it to advance out of a conventional dispenser, as described further below. In particular, and referring briefly to FIG. 3, as the loop 22 is pulled between teeth 30 (or another dental structure such as a crown or bridge), the teeth apply a force f2 that compresses the loop 22 against its natural resiliency until the restoring force f1 of the loop provides an assist to restore the loop to its unflexed shape (FIG. 2).

Optionally, as shown in FIG. 2A, the structure 20 can comprise a kink resistant material or a material 26 woven with a stiffening fiber 28 provided to impart a kink resistance to the floss 10.

Also, optionally, the loop can comprise more than one overlapping loops extending to the same side of the floss 10, commonly bound to the knot 12. Alternatively, there can be loops 22 extending away from both sides of the floss 10 from a commonly bound knot location L.

Referring now to the ends 24 illustrated in the figures, the ends provide a brush-like element at each location L along the length of floss 10 at a respective knot 12. In particular, the ends 24 can have a frayed characteristic as a result of being cut from a length of material. The frayed ends impart friction to the teeth and gums separate and apart from use of a conventional floss, including within the interstices between teeth that are difficult to reach with a brush. The ends serve as a brush and move independent of the loop. As such, while the brush or ends 24 and the loop 22 can be commonly bound at the same knot 12, when both of these components are part of the structure 20, they operate independent from one another to remove debris from gumline or from between two teeth or from between two implants.

In one implementation, the ends 24 can be, for instance, ¼″ long. In a preferred implementation, the ends are part of the same piece of material that is used to define the loop, as a result of forming one or more loops in a segment of material and cutting an opposite end to provide a loop and ends of a desired length.

In one variation, the loop and ends can comprise floss-like material that is doubled over upon itself and bound by the knot 12 such that the ends, in such an arrangement, provide a loose bundle of bristles at each location L along the length of floss 10.

The structures can be formed and then bound to the floss 10 by knots 12, or can be formed in the floss 10 itself and then cut to define the loop 22 and ends 24 described herein.

The structures described herein are compatible with conventional floss threaders in that the structures 20 do not impede threading the floss between teeth or other dental structures. To the contrary, the structures yield, as needed to accommodate tight spaces. Floss having the structures described herein can be readily removed from the threader the same as conventional floss.

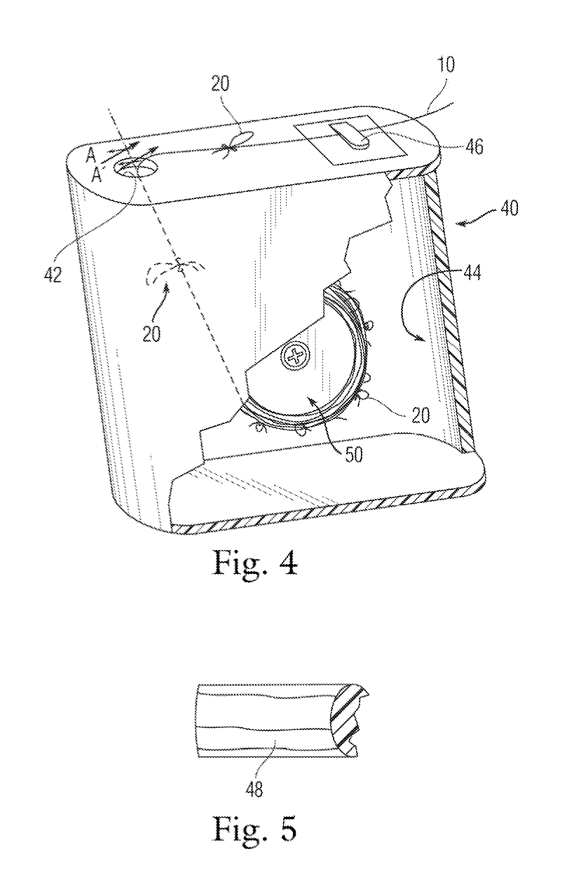

Turning now to FIG. 4, a floss dispenser 40 is shown partially broken away to reveal structures 20 along the floss 10 being dispensed from a spool 50. The floss is withdrawn from the dispenser 40 in a conventional manner by passing the floss through an aperture 42 that permits passage of the floss from an interior 44 of the dispenser to an exterior where it can be cut at a cutter 46. As the floss 10 is withdrawn from the dispenser, the structures 20 come into contact with and pass through the aperture 42. As shown in the detail view of FIG. 5, the aperture can have an edge that is configured to provide smooth withdrawal of the dental floss from the dispenser. For example, the edge 48 can be convexly rounded about the perimeter of the aperture so that as the floss is pulled, the structure can engage and be guided without catching on the edge of the aperture. As will be understood, multiple spools 50 can be commonly provided in a single dispenser 40 if different size structures 20 are to be provided on separate lengths of dental floss.

To use the dental floss according to the present invention, the user positions the floss in his or her mouth in a conventional manner and slides the floss between teeth and other structures. The structures 20 provide an active assist to the debris removal function of the floss 10, by snaring or otherwise capturing food and debris in the loop 22, by brushing plaque and muck using the ends 24, or both when both components are part of the structure 20. If multiple size structures are provided, then the user can select which size structure best fits the size of the space to be cleaned. On the other hand, if the structure 20 becomes lodged within the teeth or other dental structure, the user can pull the floss in an opposite direction to free the structure so that the floss can again be worked back and forth between the teeth and through spaces between any other dental structures from the tongue side to the cheek side and back again. The loop 22 and ends 24 cause the food to adhere to the floss and be held in position as the floss is removed. The teeth can then be brushed in the regular manner and the food can be rinsed out of the mouth.

Although the forgoing invention has been described in some detail by way of illustration and example, it will be readily apparent to those of ordinary skill in the art that changes and modifications may be made without departing from the spirit or scope of the recitations in the appended claims and fair equivalents thereof.

I claim:

1. A dispenser for dispensing a length of dental floss or tape, the dental floss or tape having first and second ends and the length extending therebetween, comprising:
a spindle supporting the length of dental floss or tape;
a housing that supports the spindle for rotation therein and having an aperture and a cutting element;
at least a first knot along the length; and
a loop at the first knot, the loop defining a yieldable snare for capturing food that passes through the aperture while being dispensed from the spindle.

2. A dispenser as in claim 1, wherein the loop comprises the same material as the length of dental floss or tape.

3. A dispenser as in claim 1, wherein the loop comprises a separate piece of material than the length of dental floss or tape, and wherein the loop is bound to the length by the first knot.

4. A dispenser as in claim 3, wherein the separate piece of material further comprises at least first and second ends, opposite the loop, that define a brush for removal of debris from gumline or from between two teeth or from between two implants.

5. A dispenser as in claim 4, wherein the loop has a diameter of about ¼ inch.

6. A dispenser as in claim 5, further comprising a second knot and having a loop associated therewith, wherein the second knot is spaced about 3 inches to about 6 inches from the first knot.

7. A length of dental floss or tape, the dental floss or tape having first and second ends and the length extending therebetween, comprising:
at least a first knot along the length; and
at least a loop at the first knot or a brush at the first knot, the loop defining a yieldable snare for capturing food and the brush comprising ends configured for the removal of debris from gumline or from between two teeth or from between two implants.

8. A length of dental floss or tape as in claim 7, wherein the loop comprises the same material as the length of dental floss or tape.

9. A length of dental floss or tape as in claim 7, wherein the loop comprises a separate piece of material than the length of dental floss or tape, and wherein the loop is bound to the length by the first knot.

10. A length of dental floss or tape as in claim 9, wherein the separate piece of material further comprises the brush and is disposed opposite the loop.

11. A length of dental floss or tape as in claim 10, wherein the loop has a diameter of about ¼ inch.

12. A length of dental floss or tape as in claim 11, further comprising a second knot and having a loop associated therewith, wherein the second knot is spaced about 3 inches to about 6 inches from the first knot.

13. A length of dental floss or tape, the dental floss or tape having first and second ends and the length extending therebetween, comprising:
at least a first knot along the length;
a loop at the first knot, the loop defining a yieldable snare for capturing food; and
a brush at the first knot, the brush moveable independently of the loop and being shaped to remove debris from gumline or from between two teeth or from between two implants.

14. A length of dental floss or tape as in claim 13, wherein the brush comprises the same material as the loop and includes first and second ends opposite the loop.

15. A length of dental floss or tape as in claim 13, wherein the loop and the brush comprise the same material as the length of dental floss or tape.

16. A length of dental floss or tape as in claim 13, wherein the loop comprises a separate piece of material than the length of dental floss or tape, and wherein the loop is bound to the length by the first knot.

17. A length of dental floss or tape as in claim 13, wherein the loop has a diameter of about ¼ inch.

18. A length of dental floss or tape as in claim 13, further comprising a second knot and having a loop and brush associated therewith, wherein the second knot is spaced about 3 inches to about 6 inches from the first knot.
